(19) United States
(12) Patent Application Publication
(10) Pub. No.: US 2021/0216969 A1
(43) Pub. Date: Jul. 15, 2021

(54) VIRTUAL COLLABORATION SYSTEM AND METHOD

(71) Applicant: KIMBERLY DENISE GRAY, NEW YORK, NY (US)

(72) Inventor: KIMBERLY DENISE GRAY, NEW YORK, NY (US)

(21) Appl. No.: 17/160,056

(22) Filed: Jan. 27, 2021

Related U.S. Application Data
(63) Continuation-in-part of application No. 16/022,946, filed on Jun. 29, 2018, now Pat. No. 10,939,186.
(60) Provisional application No. 62/492,459, filed on May 1, 2017.

(51) Int. Cl. G06Q 10/10; G06Q 50/20

(52) U.S. Cl. CPC G06Q 10/103; G06Q 50/20

(57) ABSTRACT

A system of virtual collaboration where the system includes at least one computing device having a processor and a memory device, the memory including software in the form of computing device-executable instructions that, when executed by the processor, cause the processor to implement: a communications interface, a user interface, and a virtual collaboration platform. The virtual collaboration platform includes, but is not limited to, a generation module, an interaction module, and a consolidation module. The virtual collaboration platform allows users to direct other users to create virtual content regarding a particular subject and generate a collaborated video. A data analytics interface and system allows user performance to be measured and provides information from which to further education and to link users to other content or rewards. Action command messages (ACM) may be viewable and replied to ACM substantially on one screen page of a commenting queue of a user interface.

### CLAIM OF PRIORITY

This application claims the benefit of and priority to U.S. provisional application No. 62/492,459, filed on May 1, 2017, titled Virtual Collaboration System and Method, and US utility application with Ser. No. 16/022,946, filed on Jun. 29, 2018, with the same title, the contents of which are both herein incorporated by reference in their entireties.

### FIELD OF THE INVENTION

The inventive concept relates generally to a virtual collaboration system and method and, more particularly, to a virtual collaboration system and method that generates sequences of videos from virtual collaboration and from a data analytics interface and system that measures user performance.

### BACKGROUND

Social media, e-learning, learning management systems (LMS), and massive open online courses (MOOCS) are computing device-mediated technologies that facilitate the creation and sharing of information, ideas, knowledge, career interests, and other forms of expression via virtual communities and networks. Users typically access social media services, e-learning, and LMS via web-based technologies on desktop and laptop computers or download services that offer social media functionality to their mobile devices (e.g., smartphones and tablet computing devices). When engaging with these services, users can create highly interactive platforms through which individuals, communities, and organizations can share, co-create, discuss, engage, share curriculums, and modify user-generated content or pre-made content posted online. Current social media, e-learning, LMS, and MOOCS platforms and plugins fail to allow users to collaborate with one another by using video comments and video responses, and social media post reply mechanisms are limited to text.

As can be seen, there is a need for a virtual collaboration system and method that generates sequences of videos from a virtual collaboration.

### SUMMARY OF THE INVENTION

The inventive concept described herein is designed to build content understanding and may further support a reciprocal relationship between brand holders and students, both of whom may benefit from that understanding. Students may become lifetime customers or potential future employees of brand holders. Enterprise and broadcast advertising partners, with their institutions, or via Charter School or Private Corporation Learning Institutions (PCLIs), or via public and private education institutions, reference the importance of reciprocal relationships for Mobile Distance Learning Initiatives (MDLI) and providing access to learning on mobile devices without specific Wi-Fi or computer requirements. The inventive concept, which may plugin to a variety of systems and networks, facilitates, therefore, understanding of content and may facilitate reciprocal contributions between users and institutions where students may contribute to tuition and content credits by any or all of creating or consuming content, providing information such as product feedback, and learning specific content pertinent to a career or a specific enterprise's needs. A student may be considered any user who is learning content. People who are teaching or presenting content may also be considered users.

In one embodiment of the inventive concept, the virtual collaboration system has a memory device having device-executable instructions that, when executed by the processor causes the processor to implement a communications interface for accessing a virtual collaboration platform over a network. The inventive concept in this embodiment has a user interface for displaying and interacting with the virtual collaboration platform, the user interface designed to allow the user to selectively direct—with at least one or more of video, text, audio, image, other reality, or tagged metadata—one or more other users to create virtual collaborated content regarding a particular subject and post collaborated content on the virtual collaboration platform. Tagged metadata is associated with a correct or desired response. The inventive concept has a generation module for generating a virtual collaboration on the virtual collaboration platform, wherein the virtual collaboration comprises an action command message (ACM) generated having at least one or more of a group consisting of a question, a plurality of questions, an assignment, a survey from a template, custom evaluation, market research, user feedback, an assessment, and a response request for a response post having at least one or more of video, text, audio, image, other reality, or tagged metadata, the virtual collaboration for at least one or more of creating, sharing, and viewing an action command message viewable substantially in real-time substantially on one screen page of a commenting queue. The user interface in this embodiment is designed to allow the user to selectively direct a response post generated having at least one or more of the group consisting of a single user response post, a multiple user string of response posts, a response post to an online management system, a response post to employee team management and corporate training platforms, a response post to a learning management system, a response post to a course, a response post to a feed, a response post to a commercial system, and a private response post. The plurality of previously generated virtual collaborations in this embodiment is selectable on the user interface to view the collaborated content and implement the interaction module for generating and adding the response post to the virtual collaboration. The inventive concept in this embodiment includes a data analytics interface to the virtual collaboration, the data analytics interface operably coupled to at least one data analytics system.

In one embodiment of the virtual collaboration system, the interaction module prompts the user interface to display a record button designed for record command capture, a live video feed taken by a video camera, and an overlay of the text on the live video feed, wherein selecting the record button records the live video feed with the overlaid text to generate the response post, the plurality of previously generated virtual collaborations selectable on the user interface to view the collaboration video of the virtual collaboration and implement the interaction module for generating and adding the response post to the virtual collaboration.

In one embodiment of the virtual collaboration system, the interaction module is designed for scrolling to view the action command message text in associated video capture screens of computing devices and adding the response post to the virtual collaboration and may include an ACM with enabled record command capture.

In one embodiment of the virtual collaboration system, the interaction module prompts reply options to the action command message generated wherein the response post is generated by at least one or more of the group consisting of tapping, swiping, gesturing, and audio commanding at least one or more of text, icons, and multiple-choice icons in associated video capture screens of computing devices and adding the response post to the virtual collaboration.

In one embodiment of the virtual collaboration system, the interaction module prompts reply options to the action command message generated wherein the response post is at least one or more of a text and audio response and adding the response post to the virtual collaboration. In this embodiment, the response post may include at least one or more of video and other reality.

In one embodiment of the virtual collaboration system, a data analytics interface is operably coupled to at least one or more of a learning management system, an online performance management system, a massive open online course, a government agency, employee training management, team management, broadcast system, tutoring, online training, a teaching or certification platform, a corporate institution, and an educational institution, wherein virtual collaboration is processed by the at least one data analytics system to generate at least one performance measure. In this embodiment of the virtual collaboration system, the learning performance measure of virtual collaboration includes at least one or more of the group consisting of comprehension, quality of decision, quality of response, time spent, response time length of engagement, user behavior, and quality of standards set by an action command message creator. Comprehension is defined to include both evaluation of performance and understanding where understanding can further be defined as mastery as a person of ordinary skill in the art might recognize as the difference between learning enough for long enough to pass a test when compared to internalizing lessons for access after completing the associated lesson. In this embodiment of the virtual collaboration system, the learning performance measure of virtual collaboration may include feedback about where a student should focus, efficient learning methods for that student, freedom to advance to new material, and comprehension risks, the feedback oriented toward subject mastery. One of ordinary skill in the art would recognize the measures listed in this paragraph as learning measures from which curriculum can be custom designed for a given student or groups of students. Data analytics from the data analytics interface and system can show where the student needs to focus learning, the learning methods best suited for the student or subject, when the student is ready to advance, and what comprehension risks may be present, along with measuring productivity, engagement, and retention in real-time.

In one embodiment of the virtual collaboration system, the data analytics interface is operably coupled to at least one or more of an enterprise computer network, broadcast network, social media network, and public access network, wherein the virtual collaboration is processed by at least one data analytic system to generate at least one or more of content items, content credits, or rewards.

One embodiment of the virtual collaboration method involves producing a virtual collaboration with a software applet operating on at least one memory device executing instructions causing a processor to implement a communications interface accessing the virtual collaboration platform over a network. This embodiment involves displaying and interacting on a user interface with the virtual collaboration platform, the user interface allowing the user to selectively direct—with at least one or more of video, text, audio, image, other reality, or tagged metadata—one or more other users to create virtual collaborated content regarding a particular subject and post collaborated content on the virtual collaboration platform. This embodiment further involves generating with a generation module a virtual collaboration on the virtual collaboration platform, wherein the virtual collaboration comprises an action command message generated having at least one or more of a question, a plurality of questions, an assignment, a survey from a template, custom evaluation, market research, user feedback, an assessment, and a response request for a response having at least one or more of video, text, audio, image, other reality, or tagged metadata, the virtual collaboration for at least one or more of creating, sharing, and viewing an action command message viewable substantially in real-time substantially on one screen page of a commenting queue. This embodiment further involves the user selectively directing through the interface a response post generated having at least one or more of a single user response post, a multiple user string of response posts, a response post to an online management system, a response post to employee team management and corporate training platforms, a response post to a learning management system, a response post to a course, a response post to a feed, a response post to a commercial system, and a private response post. This embodiment further involves selecting on the user interface the plurality of previously generated virtual collaborations to view the collaborated content and implement the interaction module for generating and adding the response post to the virtual collaboration. This embodiment further involves operably coupling the virtual collaboration to a data analytics interface further operably coupled to at least one data analytics system.

In one embodiment of the virtual collaboration method, the user is prompted by the interaction module to display a record button designed for record command capture, a live video feed taken by a video camera, and an overlay of the text on the live video feed, whereby selecting the record button records the live video feed with the overlaid text to generate the response post, the plurality of previously generated virtual collaborations selectable on the user interface to view the collaboration video of the virtual collaboration and implement the interaction module for generating and adding the response post to the virtual collaboration.

In one embodiment of the virtual collaboration method, the user views the interaction module and scrolls to view video capture screens of an associated computing device and adds the response post to the virtual collaboration and may include an ACM with enabled record command capture.

In one embodiment of the virtual collaboration method, the user is prompted through the interaction module to reply to the action command message by options generated wherein the user generates a response post by at least one or more of tapping, swiping, gesturing, and audio commanding at least one or more of text, icons, and multiple-choice icons in associated video capture screens of computing devices and adding the response post to the virtual collaboration.

In one embodiment of the virtual collaboration method, the interaction module prompts reply options to the action command message generated wherein the response post is at least one or more of a text and audio response and adding the response post to the virtual collaboration. In this embodiment of the virtual collaboration method, the response post may include at least one or more of video and other reality.

In one embodiment of the virtual collaboration method, at least one performance measure is generated by at least one data analytics interface and system from virtual collaboration data either or both received and transmitted through a data analytics interface and system that is operably coupled to at least one or more of a learning management system, an online performance management system, a massive open online course, a government agency, employee training management, team management, broadcast system, tutoring, online training, a teaching or certification platform, a corporate institution, and an educational institution. In this embodiment of the virtual collaboration method, the learning performance measure of virtual collaboration may include at least one or more of comprehension, quality of decision, quality of response, time spent, response time length of engagement, user behavior, and quality of standards set by an action command message creator. In this embodiment of the virtual collaboration method, the learning performance measure of virtual collaboration may include feedback about where a student should focus, efficient learning methods for that student, freedom to advance to new material, and comprehension risks, the feedback oriented toward subject mastery. One of ordinary skill in the art would recognize the measures in this paragraph as learning measures from which curriculum can be custom designed for a given student or groups of students. For example, as a student is able to proficiently assess a posed problem such as a math problem, decide on how to handle it, and handle it, and to do so at faster rates, the probability the student has mastered the material goes up. Such measure can be assessed by a teacher, by artificial intelligence, or both.

In one embodiment of the virtual collaboration method, data from the virtual collaboration is sent through the data analytics interface and system operably coupled to at least one or more of an enterprise computer network, broadcast network, social media network, and public access network, wherein the virtual collaboration is processed by the at least one data analytic system to generate at least one or more of content items, content credits, or rewards.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a schematic view of a computing device of an embodiment of the inventive concept.

FIG. 2 illustrates a schematic view of a network of computing devices of an embodiment of the inventive concept.

FIG. 3 illustrates a schematic view of a software of an embodiment of the inventive concept.

FIGS. 4A-4C illustrate a flow chart of a method of an embodiment of the inventive concept.

FIG. 5 illustrates a second flow chart of a method of an embodiment of the inventive concept.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The inventive concept has an action command messaging (ACM) plugin with at least one or more dashboard data analytics interface and systems and methods of data analysis. The ACM plugin may be for push and pull notifications for data, content, and software. Data analytics interface and system results are based on the ACM and response post for learning engagement, feedback, understanding, evaluation, retention, and correct response, using metadata captured from text, video-to-text, and audio-to-text metadata to understand whether responses are correct and may also assess understanding through other measures noted herein. Using video-to-text annotation to identify correct responses based on metadata tagged keywords for the ACM adds to the usefulness of the inventive concept. Text response capabilities further enhance compliance with the Americans with Disabilities Act of 1990 or ADA, for K-12 and post-secondary institutions under the US Department of Education and international equivalents.

In one embodiment of the inventive concept, ACM is a command-driven virtual evaluation. The computer or mobile computing device directs people to respond to text or icons shared in the video capture screen of an associated computer or mobile computing device.

A plugin is a software component that adds a specific feature to another computer software program. A given plugin may become an operably coupled element of the inventive concept. Plugins may be agnostic to all types of network accessibility, i.e. education, enterprise, and broadcast. Plugins may include one or more of ACM, virtual collaboration, and data analytics results. The inventive concept in some embodiments hosts the data analytics interface and system for the virtual collaborations created from ACM and converts data analytics results to understanding-based outcomes from which to measure performance and understanding of associated content.

A user or student is a person engaged with the inventive concept for learning and may also be a person engaged with the inventive concept for teaching or for collaborative teaching such as, but not limited to, Socratic teaching methods, pedagogy, or train the trainer methods.

The inventive concept, in some embodiments, is designed to allow a user to connect brands and advertisers and help education gain more funding through accredited mandate mobile learning, utilizing public access channels for community college and city and county government, along with social and community networks and social media. Broadcast networks may link to at least one or more of universities; community college public access; federal, state, or other authority permission to utilize these channels for education content; and funds from ads that support institutions and student tuition. Other networks such as content streaming platforms, premium cable, and television networks may be included. Action command messaging in some embodiments is designed to create virtual responses that enable advertisers to partner with institutions to get feedback from students. In these embodiments, the virtual responses may convert to branded content or educational advertising (EduAds) and may further convert to one or more of credits towards tuition, product service credits, or college funds in exchange for that content. As such, the inventive concept may facilitate government programs such as military, healthcare, and humanitarian services where educational requirements are aligned with service commitments and enterprise equivalents where an enterprise can facilitate educating students for specific roles and agreed-upon obligations. In these embodiments, the inventive concept may utilize public access channels that have been dedicated for community colleges or have relationships structured with other educational institutions such as four-year private and publicly funded institutions.

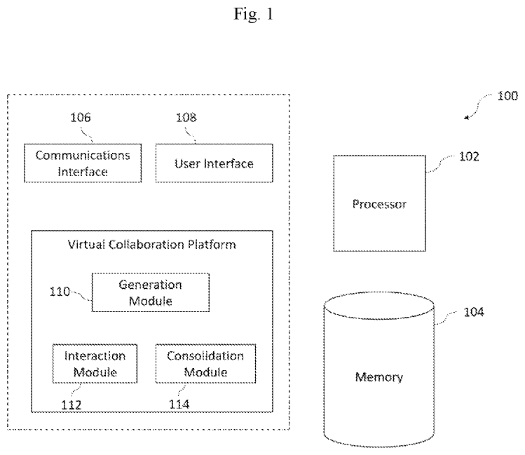

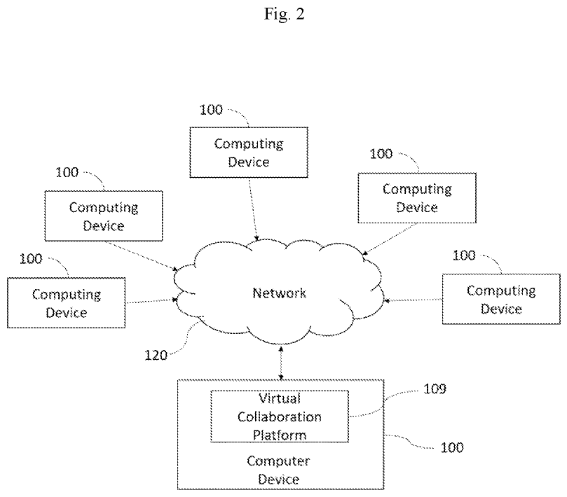

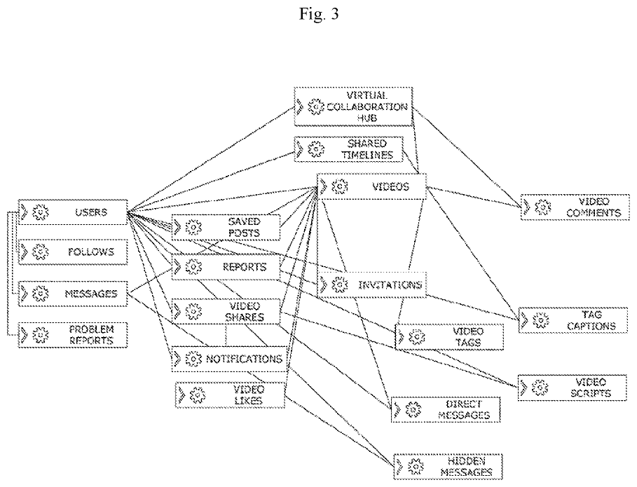

Referring to FIGS. 1 through 3, the inventive concept includes a system of virtual collaboration. The system includes at least one computing device 100 having a processor 102 and a memory device 104. The memory device 104 includes software in the form of computing device-executable instructions that, when executed by the processor, cause the processor to implement: a communications interface 106, a user interface 108, and a virtual collaboration platform 109. The virtual collaboration platform 109 includes, but is not limited to, a generation module 110, an interaction module 112, and a consolidation module 114.

The computing device 100 is at least the processor 102 and the memory device 104. The computing device 100 may include a smart phone, a tablet computer, a laptop, a desktop, and the like. The computing device 100 may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In some embodiments, the computing device 100 includes the processor 102, the memory device 104, the user interface 108, and the communication interface 106. In some embodiments, the processor 102 includes hardware for executing instructions, such as those making up a computing device program. The memory device 104 includes main memory for storing instructions such as computing device program(s) for the processor to execute, or data for the processor 102 to operate on. The memory device 104 may include an HDD, a floppy disk drive, flash memory, an optical disc, a magneto-optical disc, magnetic tape, a Universal Serial Bus (USB) drive, a solid-state drive (SSD), or a combination of two or more of these. The memory device 104 may include removable or non-removable (or fixed) media, where appropriate. The memory device 104 may be internal or external to the computing device 100, where appropriate. In some embodiments, the memory device 104 is non-volatile, solid-state memory.

The user interface 108 is for displaying and interacting with the virtual collaboration platform 109. The user interface 108 includes hardware, software, or both providing one or more interfaces for user communication with the computing device. As an example, and not by way of limitation, the user interface 108 may include a keyboard, keypad, microphone, monitor, mouse, printer, scanner, speaker, still camera, stylus, tablet, touchscreen, trackball, video camera, another user interface or a combination of two or more of these.

The communications interface 106 is for accessing a virtual collaboration platform 109 over a network 120. The communication interface 106 includes hardware, software, or both providing one or more interfaces for communication (e.g., packet-based communication) between the computing device 100 and one or more other computing devices 100 on one or more networks 120. As an example, and not by way of limitation, communication interface 106 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 106. As an example, and not by way of limitation, the computing device 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks 120 may be wired or wireless. As an example, the computing device 100 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing device 100 may include any suitable communication interface 103 for any of these networks 120, where appropriate.

The virtual collaboration platform 109 may include a standalone software program, such as a social media program or an e-collaboration program. The standalone program may include a plurality of different user's that create profiles with identifying pictures, videos, personal data, and the like. Alternatively, the virtual collaboration platform 109 may include an application programming interface (API) plugin as a video commenting plugin tool that agnostically integrates a video commenting feature into already existing software platforms, web servers, and mobile based platforms. The API plugin may integrate the video commenting feature described in more detail below into existing e-learning platforms, such as but not limited to LMS and MOOCS, e-commerce, social media network platforms, news platforms, media platforms, blog platforms, product and service website platforms, and the like to enable real time video response.

As a social media standalone software program, the virtual collaboration platform 109 may include a main page and a plurality of individual user profile pages. The main page may include a news feed, and each of the plurality of user profile pages may include a user's picture, video, and shared user personal data. The virtual collaboration platform 109 allows users to friend request one another, similar to other social media platforms. Once users are friends, the users may view each other's profile pages, engage in instant messaging via a message portal, and tag one another for virtual collaborations, as described in further detail below.

The virtual collaboration platform 109 supports a generation module 110, an interaction module 112, and a consolidation module 114 as a standalone software program or as an API plugin. The generation module 110 is for generating a virtual collaboration on the virtual collaboration platform 109. To generate a virtual collaboration, the user may upload a text, a video, an image, or a combination thereof, which may be original content created at the time of the creation of the virtual collaboration or extracted from a memory device 104 of the computing device 100. Users may create a virtual collaboration between user to user, user to group, and user to public. If the user tags specified users, the virtual collaboration may only show up on the specified users' profile page, the specified user's message portal, the specified user's news feed, or combination thereof. If the user makes the virtual collaboration public, the virtual collaboration may appear on the news feed for all of the user's friends to view. The initial post may include an instruction or request for a type of response posts. For example, the initial post may include an image having a text. The text may be the instructions.

The generation module 110 may be called “Script Share.” Script share directs others to create content using Action Command Messages (ACM). ACM is when a user creates a post using Script Share and tags other users to create content based on the text instructions. In certain embodiments, the Script Share may offer different template formats for users to utilize. For example, the template formats may include, but are not limited to, music video, series, reality, video podcast, branded content (advertisements), learning and training-based curriculum, and the like. The template formats indicate different themes in which the Script Share feature is used.

Other users may respond to the initial message within the virtual collaboration. The interaction module 112 is for adding a response post to the virtual collaboration via the ACM. The response videos are original content created at the time of the creation of the response post. In certain embodiments, the interaction module 112 prompts the user interface 108 to display a record button designed for, but not exclusive to, record command capture, a live video feed taken by a video camera, and an overlay of the text on the live video feed. The user may select the record button, which records the live video feed with the overlaid text to generate a response post. A plurality of different users may generate a response post including a video of a response to the instructions with the overlaid text. Each of the response posts are posted to the virtual collaboration.

The present inventive concept then merges the video responses together, creating a collaboration video. The consolidation module 114 is for generating a collaboration video of the virtual collaboration. The collaboration video is a plurality of the response posts linked together as a string. The collaboration video is displayed on the user interface as a sequence of the plurality of the response videos side by side. For example, the user interface 108 may display an image of a strip of film. Each one of the response post videos may be disposed in order within the strip of film. The user profile picture may be embossed over each of the response post videos to indicate who made the response post. Each of the response videos may be selectable from the user interface 108 to play individually or as a sequence of videos starting from the selected response video.

As mentioned above, if the user makes the virtual collaboration public, the virtual collaboration may appear on the news feed for the user's friends. If the user makes the virtual collaboration private, the virtual collaboration may appear on the news feed of the selected users. The news feed of each individual user may include a plurality of previously posted public or private virtual collaborations, in which the user may scroll through and select. When the user selects a previously posted public or private virtual collaboration, the user may view the collaboration video of the previously generated virtual collaboration. In certain embodiments, the user may generate and add a response post to any of the previously generated virtual collaborations on the user's news feed.

As mentioned above, the virtual collaborations may be created using template formats such as, but are not limited to, music video, series, reality, video podcast, branded content (advertisements), learning and training-based curriculum, and the like. The virtual collaboration platform 109 may include a virtual collaboration hub. The virtual collaboration hub categorizes each of the virtual collaborations into groups based on the template format. User's may access the virtual collaboration hub via the virtual collaboration platform and view the virtual collaborations within their groups, in which the user may scroll through and select. When the user selects a previously posted public or private virtual collaboration, the user may view the collaboration video of the previously generated virtual collaboration. In certain embodiments, the user may generate and add a response post to any of the previously generated virtual collaborations in the virtual collaboration hub.

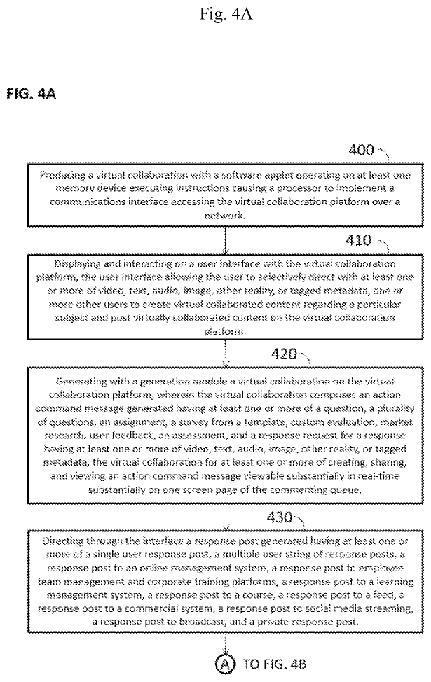

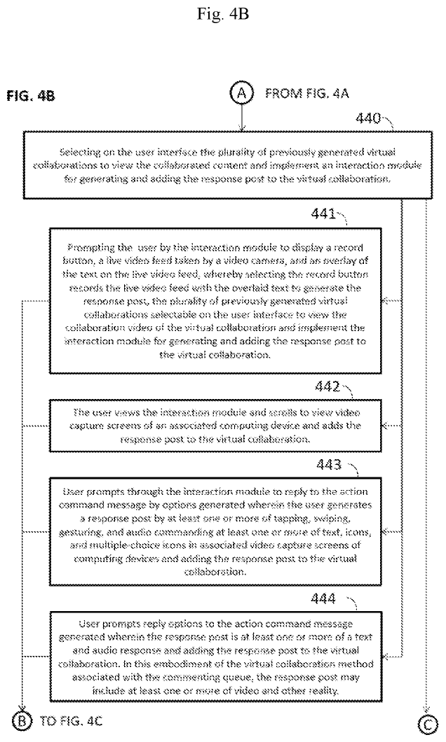

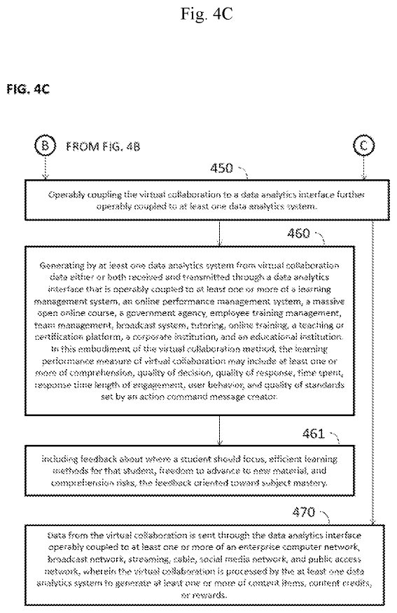

FIGS. 4A-C illustrate embodiments of the virtual collaboration method involving producing a virtual collaboration with a software applet operating on at least one memory device executing instructions causing a processor to implement a communications interface accessing the virtual collaboration platform over a network 400. This embodiment involves displaying and interacting on a user interface with the virtual collaboration platform, the user interface allowing the user to selectively direct with at least one or more of video, text, audio, image, other reality, or tagged metadata, one or more other users to create virtual collaborated content regarding a particular subject and post collaborated content on the virtual collaboration platform 410. Tagged metadata is associated with a correct or desired response.

Other reality is defined in this disclosure to mean virtual reality, augmented reality, holographic imagery, three-dimensional imagery, and other computer-generated presentations that immerse a user in a computer environment typically with at least one or more of headsets, glasses-type eyewear, contact lenses, holograms, three-dimensional imagery such as drone displays or holographic fans, three dimensional laser imagery, and other visual environments such as those created by at least one or more of merging photographic or video imagery such as photographs from three hundred and sixty degree cameras and visual environments that may be entirely computer generated or may include computer generated components employed with otherwise true-to-life imagery. Interaction in other realities may be gesture based, may involve tapping virtual texts, icons, or metatag data, and may include one or more of haptic responses and commands, responding to or generating audio signals such as voice commands, and eye recognition.

This embodiment further involves generating with a generation module a virtual collaboration on the virtual collaboration platform, wherein the virtual collaboration comprises an action command message generated having at least one or more of a question, a plurality of questions, an assignment, a survey from a template, custom evaluation, market research, user feedback, an assessment, and a response request for a response having at least one or more of video, text, audio, image, other reality, or tagged metadata, the virtual collaboration for at least one or more of creating, sharing, and viewing an action command message viewable substantially in real-time substantially on one screen page of a commenting queue 420. This embodiment further involves the user selectively directing through the interface a response post generated having at least one or more of a single user response post, a multiple user string of response posts, a response post to an online management system, a response post to employee team management and corporate training platforms, a response post to a learning management system, a response post to a course, a response post to a feed, a response post to a commercial system, and a private response post 430. This embodiment further involves selecting on the user interface the plurality of previously generated virtual collaborations to view the collaborated content and implement an interaction module for generating and adding the response post to the virtual collaboration 440. This embodiment further involves operably coupling the virtual collaboration to a data analytics interface further operably coupled to at least one data analytics system to create a data analytics interface and system 450.

In one embodiment of the virtual collaboration method, the user is prompted by the interaction module to display a record button for designed for record command capture, a live video feed taken by a video camera, and an overlay of the text on the live video feed, whereby selecting the record button records the live video feed with the overlaid text to generate the response post, the plurality of previously generated virtual collaborations selectable on the user interface to view the collaboration video of the virtual collaboration and implement the interaction module for generating and adding the response post to the virtual collaboration 441.

In one embodiment of the virtual collaboration method, the user views the interaction module and scrolls to view video capture screens of an associated computing device and adds the response post to the virtual collaboration 442.

In one embodiment of the virtual collaboration method, the user is prompted through the interaction module to reply to the action command message by options generated wherein the user generates a response post by at least one or more of tapping, swiping, gesturing, and audio commanding at least one or more of text, icons, and multiple-choice icons in associated video capture screens of computing devices and adding the response post to the virtual collaboration 443.

In one embodiment of the virtual collaboration system and method, the interaction module prompts reply options to the action command message generated wherein the response post is at least one or more of a text and audio response and adding the response post to the virtual collaboration. In this embodiment of the virtual collaboration method, the response post may include at least one or more of video and other reality 444. This embodiment may be known as an all-in-one commenting queue.

In one embodiment of the virtual collaboration method, at least one performance measure is generated by at least one data analytics system from virtual collaboration data either or both received and transmitted through a data analytics interface that is operably coupled to at least one or more of a learning management system, an online performance management system, a massive open online course, a government agency, employee training management, team management, broadcast system, tutoring, online training, a teaching or certification platform, a corporate institution, and an educational institution. In this embodiment of the virtual collaboration method, the learning performance measure of virtual collaboration may include at least one or more of comprehension, quality of decision, quality of response, time spent, response time length of engagement, user behavior, and quality of standards set by an action command message creator 460.

In one embodiment of the virtual collaboration method, the learning performance measure of virtual collaboration includes feedback about where a student should focus, efficient learning methods for that student, freedom to advance to new material, and comprehension risks, the feedback oriented toward subject mastery 461.

In one embodiment of the virtual collaboration system and method, data from the virtual collaboration is sent through the data analytics interface operably coupled to at least one or more of an enterprise computer network, broadcast network, social media network, and public access network, wherein the virtual collaboration is processed by the at least one computer analytic system to generate at least one or more of content items, content credits, or rewards 470.

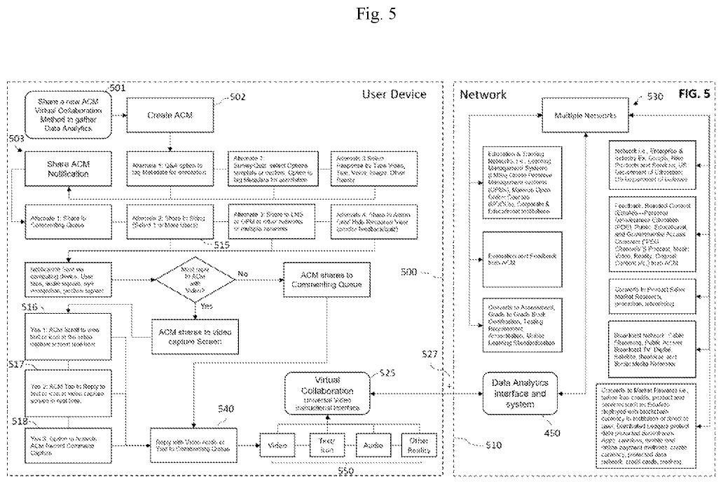

FIG. 5 illustrates the inventive concept and shows how an ACM within a User Device 500 may appear as an application plugin 527 to a Network 510, allowing a user to create ACM 502 and share ACM 503 to multiple computer systems across multiple networks 530 including, but not limited to, educational institution portals; enterprise organizations; Learning Management Systems as exemplified by Blackboard and Instructure; Microsoft Education and Microsoft Teams; Online Program Management systems; Massive Open Online Courses; Advertisers; Social Media platforms such as Twitter, Instagram, Facebook, TikTok; other social media-based blogs; platforms accessed via a computing device, public and private; Organization and Corporation OPM management systems such as Google related products including but not limited to Google Classroom, Google Forms, and Google Education; to create a virtual collaboration 525 tethered to, with reference to FIG. 4C, the data analytics interface and system 450 in real-time for understanding and content conversion through video, audio, text, and metadata. Each of the exemplified networks may be independent-of or interrelated-to each other as would fit the description one of ordinary skill in the art would recognize as a network or web on an Internet system. The inventive concept is designed to plugin to other such platforms that might arise.

ACM creates virtual collaboration 525 where an administrator can understand users, gain feedback, and measure success using the data analytics interface and system 450 based on human behavior, time spent, productivity, assessment and evaluation of engagement, and retention over time. Delivered results include at least one or more of an evaluation, feedback, grades, assessments, certifications, and branded content.

Multiple networks 540 are computer networks of an overall network 510 that permit computers on the computer network to communicate with the network 510 at any time during operation. Multiple networks 540 may have educational components for generating understanding of teachable material and enterprise components that may generate commercial values such as product sales, the creation of saleable material such as data, or credits for the institutions, tuition, or product and services.

Multiple networks 540 link to exemplary content and systems displayed in the category networks 510 and are exemplary. Data may be drawn from or sent to a learning management system or other educational network. Online Personal Management (OPM) Commercial system networks that may be used in the inventive concept in some embodiments include, but are not limited to, broadcast television, cable, streaming, social media, and theatrical. Broadcast networks that may be used in the inventive concept in some embodiments may include one or more of, but are not limited to, broadcast systems, ACM messages to television, broadcast from ACM branded content cable, content enterprises such as Netflix, ratings systems as exemplified by Neilson, public access channels for community colleges and local city government, CSpan, community colleges, student generated content created using ACM, commenting queues, or string-and-record command capture. The inventive concept may, in some embodiments, utilize public broadcast networks for community colleges and universities and may utilize government channels to display ACM virtual collaborations within FCC guidelines for use of those channels. Public broadcast networks may be defined as Public, Educational, and Governmental Access Channels (“PEG Channels”). The inventive concept may use network plugin options where the ACM plugin facilitates converting branded content to one or more of advertising, promotions, and sales conversions for one or more of products and services.

Users may have access to EduAd tuition credits. An EduAd, used in some embodiments, is ACM directed user-created brand content as a part of a market rewards partnership with public and private sector companies to pay users to include students, instructors to create content, and native advertising, which may lead to direct sales, advertisement, market research, or product and service understanding. The inventive concept may be deployed with an ACM plugin to create the virtual collaborations (video, audio, text) of a UVII (Universal Video Instructional Interface) data analytics interface and system 450, this being one embodiment of the data analytics interface and system 450. Many embodiments are limited to video, audio, and text. Some embodiments may include other reality. The inventive concept, therefore, in some embodiments, is designed to reduce a digital divide in elements such as to provide accessibility to learning with off-line capabilities, address black-belt-style training programs such as six sigma programs, rural Internet access for education where bandwidth is unconducive for Internet use, and government programs inclusive of local, city, state, province, country, or other regional tiers. The best performing student may access the market rewards opportunities based on the data analytics interface and system 450 evaluation.

The inventive concept in some embodiments has one or more plugins through and application programming interface (API) and is designed to work as a plugin with such systems as Deep Link, Learning Tool Interoperability (LTI), Magic Link and other computing device systems and methods to enable ACM to create virtual collaborations 525 with data analytics interface and system 450 that may be in the form of dashboard analytics that may further have push and pull data receipt and transmission. The data analytics interface and system 450 are designed to help a user of the virtual collaboration 450 of the virtual collaboration system and method to gain understanding of content from teachers, instructors, and administrators, and prepared content through virtual evaluation and feedback by converting video and video-to-text annotation to metadata and tagged metadata for correct responses for personalized understanding and to create directed content for the purpose of evaluation, or advertising branded content linked to an evaluation, which may convert to market rewards via network integration platforms. Market rewards may be defined as reciprocal rewards relationships with students, users, brands, and institutions to deliver such benefits as discounts, tuition credits, product services, monetary compensation (i.e. cashless payment, blockchain, bitcoin, and traditional credit card and cash transfers to provide market rewards in exchange for branded content and EduAds. Content may be tiered content wherein one or more core lessons are organized as a system, subsystem, and a component of a greater system, an approach one of ordinary skill in the art would recognize as important for gaining understanding of the material within a system. Tuition credits, student loans, or products and services may be associated with education content and lessons. The data analytics interface 450 may measure engagement, productivity, and commercialization potential, commercialization potential further allowing ways for students to remunerate education providers.

Data analytics interface and system 450 based on the ACM and response posts may also support branded content, market research, advertising, and promotion content.

Data analytics from the data analytics interface and system 450 is a process of inspecting, cleansing, transforming, and modeling data with the goal of discovering useful information, understanding information, informing conclusions, and supporting decision-making. The data analytics interface and system 450 has multiple facets and approaches, encompassing diverse techniques under a variety of names, and is used in different business, science, educational, and social science domains. For example, with built-in ACM connectivity for 5G networks and beyond, an ACM chip could enable all devices with ACM virtual collaboration 525, access to an ACM commenting queues system 540, and sharing the data analytics interface and system 450. The inventive concept in many embodiments is designed to use the data analytics interface and system 450 to assess student understanding of educational content or consumer decision-making for a brand. The assessment includes, but is not limited to, tracking time spent, behavior of users, retention, productivity, assessing and evaluating response correctness, evaluating engagement, number of replies, number of posts, user interest, and other comprehension measures. The data analytics interface and system 450 allows a deeper assessment of virtual collaboration and may also include common features such as tracking uses of like notifications and ACM information sent with a push notification going to live alerts. Push notifications in some embodiments may further serve as an integration point for the network system and may go to each applicable network, exemplified but not limited to Class Roster, LMS Grade book, Instructor Portal Enterprise OMP Analytics, company databases, eCommerce and cashless payment providers, Broadcast Network data systems, individual stations, during air time, commercial and public access air time, via satellite, Neilson data, broadcast metadata providers for advertisers, wherein streamed feeds are available for the commenting queue 540.

Action Command Messaging (ACM) is defined as a command-driven method of sharing a notification of one or more text, icon, and image to the video capture screen to direct a user to create a virtual collaboration in real-time with a plurality of responses. 501 Responses may be limited to an individual and may include more than one individual. Responses may be public, limited to a defined group or those people or machines (computers, artificial intelligence) otherwise given permission for access, and may be private depending on at least one or more of settings, circumstances, and instructions.

One embodiment of the inventive concept includes the ACM commenting queue system 540. The inventive concept displays ACMs and enables users to reply with a plurality of ways to respond—video, audio, text, other reality 550—to create the virtual collaboration, where a given response post involves at least one or more of video, audio, text, and other reality. A given commenting queue on one or more screens allows a user to create, share, and view an ACM virtual collaboration 525 in real-time on one screen without uploading or leaving the screen other than to record the collaboration.

Commenting queue 540 is defined as an all-in-one response and display screen associated with a user interface. The commenting queue 540 is where a user can reply to ACM and view ACM with a plurality of response types and without leaving, with reference to FIG. 1, the user interface 108. The ACM generated virtual collaborations 525 in some embodiments is the commenting queue 540 in an all-in-one screen display. The ACM for creating the virtual collaboration 525 is disclosed herein with a plurality of response post options. The commenting queue 540 enables the user to view substantially all of the action command message (ACM) virtual collaboration responses 525 and reply to an ACM in real time for their computing device or other medium to create a new response with the option to use at least one or more of video, audio, or text. These plurality of response options may be displayed in the commenting queue 540 with either or both user avatars or user profile images. ACM may display in the record capture screen for students to reply from the commenting queue 540 screen and add response posts in real time. Users in some embodiments can at least one or more of swipe, tap, and preview the virtual collaborations 525 from the ACM. The substantially all-in-one screen displayed does not require the user to upload media from the computing device but to record video, audio, or text responses to ACM, video, text, icons, photos, and other media in real time. A user may, in some embodiments, view at least one or more of the plurality of responses from other users on the same ACM, post to course/feed, and post to string if they are one of one or more users tagged in the ACM.

One embodiment of the inventive concept includes an ACM String 515. The ACM string involves sharing the ACM to specific users selected by administrators as the only users who may view the ACM. ACM String 515 automatically adds new virtual collaborations 525. As users respond to notifications, the new ACM String 515 messages are added to the video post automatically and populate as they are added to the users' computing devices from the same ACM notification. These replies only appear and post to the user accounts the Administrator/Instructor/Employer has added to the string 515, these being the accounts where viewing is permitted. This embodiment offers a private method to share ACMs privately and acts as a direct messaging system for video response posts. String videos open to the video capture screen and may include an ACM with enabled record command capture 518, prompting the given user's computing device screen to record with ACM text, icons, or symbols displayed on the screen.

One embodiment of the inventive concept includes an ACM Scroll 516. ACM Scroll 516 enables users to scroll down to view all ACM message text or icons in the video capture screen of computing devices and view additional characters in the ACM, or scroll to access ACM 517 Tap features, for example, selecting from multiple choice options to reply to an ACM and may be considered a derivative of Tap ACM.

One embodiment of the inventive concept includes ACM Tap 517 to on-screen text reply options to ACM notification. The tappable/click/motionable based response action may be performed by tapping text, or icons such as, but not limited to, multiple-choice options. Reply options may appear on at least one or more of a computer or mobile computing device; on a display device screen through the computer or mobile computing device; virtual reality, augmented reality, or holographic displays; motion-sensitive mediums; and voice-activated mediums.

One embodiment of the inventive concept includes ACM record capture/record command capture 518. Embodiments may further distinguish between ACM Record (Screen recording) from a computing device of the ACM creation and display response in the queue or user feed, and record command capture 518 initiating the inventive concept to record automatically and open to video capture screen. ACM administrators may activate live screen modes to reply to an action command message. In this embodiment, the response post is automatically recorded live on-screen in real-time and recorded for playback in response to an ACM on the user video capture screen. Instructors, employers, and administrators can call on one or more students, learners, employees, and administrators to respond and to activate their cameras.

The following patents are incorporated by reference in their entireties: U.S. Pat. Nos. 10,747,418, 10,356,022, 9,894,115, and 2015/0149906.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A virtual collaboration system comprising:
a memory device comprising device-executable instructions that, when executed by the processor, cause the processor to implement:
a communications interface for accessing a virtual collaboration platform over a network;
a user interface for displaying and interacting with the virtual collaboration platform, the user interface adapted to allow the user to selectively direct with at least one or more of video, text, audio, image, other reality, or tagged metadata, one or more other users to create virtual collaborated content regarding a particular subject and post collaborated content on the virtual collaboration platform;
a generation module for generating a virtual collaboration on the virtual collaboration platform, wherein the virtual collaboration comprises an action command message generated having at least one or more from a group consisting of a question, a plurality of questions, an assignment, a survey from a template, custom evaluation, market research, user feedback, an assessment, and a response request for a response post having at least one or more of video, text, audio, image, other reality, or tagged metadata, the virtual collaboration for at least one or more of creating, sharing, and viewing an action command message viewable substantially in real-time substantially on one screen page of a commenting queue;
the user interface adapted to allow the user to selectively direct a response post generated having at least one or more of the group consisting of a single user response post, a multiple user string of response posts, a response post to an online management system, a response post to employee team management and corporate training platforms, a response post to a learning management system, a response post to a course, a response post to a feed, a response post to a commercial system, and a private response post;
the plurality of previously generated virtual collaborations selectable on the user interface to view the collaborated content and implement an interaction module for generating and adding the response post to the virtual collaboration; and
a data analytics interface to the virtual collaboration, the data analytics interface operably coupled to at least one data analytics system.

2. The virtual collaboration system of claim 1, wherein the interaction module prompts the user interface to display a record button, a live video feed taken by a video camera, and an overlay of the text on the live video feed, wherein selecting the record button records the live video feed with the overlaid text to generate the response post, the plurality of previously generated virtual collaborations selectable on the user interface to view the collaboration video of the virtual collaboration and implement the interaction module for generating and adding the response post to the virtual collaboration.

3. The virtual collaboration system of claim 1, wherein the interaction module is adapted for scrolling to view the action command message text in associated video capture screens of computing devices and adding the response post to the virtual collaboration.

4. The virtual collaboration system of claim 1, wherein the interaction module prompts reply options to the action command message generated wherein the response post is generated by at least one or more of the group consisting of tapping, swiping, gesturing, and audio commanding at least one or more of text, icons, and multiple-choice icons in associated video capture screens of computing devices and adding the response post to the virtual collaboration.

5. The virtual collaboration system of claim 1, wherein the interaction module prompts reply options to the action command message generated wherein the response post is at least one or more of a text and audio response and adding the response post to the virtual collaboration.

6. The virtual collaboration system of claim 5, wherein the response post includes at least one or more of video and other reality.

7. The virtual collaboration system of claim 1, wherein a data analytics interface is operably coupled to at least one or more of a learning management system, an online performance management system, a massive open online course, a government agency, employee training management, team management, broadcast system, tutoring, online training, a teaching or certification platform, a corporate institution, and an educational institution, wherein virtual collaboration is processed by the at least one data analytics system to generate at least one performance measure.

8. The virtual collaboration system of claim 7, wherein the learning performance measure of virtual collaboration includes at least one or more of the group consisting of comprehension, quality of decision, quality of response, time spent, response time length of engagement, user behavior, and quality of standards set by an action command message creator.

9. The virtual collaboration system of claim 8, wherein the learning performance measure of virtual collaboration includes feedback about where a student should focus, efficient learning methods for that student, freedom to advance to new material, and comprehension risks.

10. The virtual collaboration system of claim 1, wherein the data analytics interface is operably coupled to at least one or more of an enterprise computer network, broadcast network, social media network, and public access network, wherein the virtual collaboration is processed by the at least one computer analytic system to generate at least one or more of content items, content credits, or rewards.

11. A virtual collaboration method comprising:
producing a virtual collaboration with a software applet operating on at least one memory device executing instructions causing a processor to implement a communications interface accessing the virtual collaboration platform over a network;
displaying and interacting on a user interface with the virtual collaboration platform, the user interface allowing the user to selectively direct with at least one or more of video, text, audio, image, other reality, or tagged metadata, one or more other users to create virtual collaborated content regarding a particular subject and post collaborated content on the virtual collaboration platform;
generating with a generation module a virtual collaboration on the virtual collaboration platform, wherein the virtual collaboration comprises an action command message generated having at least one or more of a question, a plurality of questions, an assignment, a survey from a template, custom evaluation, market research, user feedback, an assessment, and a response request for a response having at least one or more of video, text, audio, image, other reality, or tagged metadata, the virtual collaboration for at least one or more of creating, sharing, and viewing an action command message viewable substantially in real-time substantially on one screen page of a commenting queue;
the user selectively directing through the interface a response post generated having at least one or more of a single user response post, a multiple user string of response posts, a response post to an online management system, a response post to employee team management and corporate training platforms, a response post to a learning management system, a response post to a course, a response post to a feed, a response post to a commercial system, and a private response post;
selecting on the user interface the plurality of previously generated virtual collaborations to view the collaborated content and implement an interaction module for generating and adding the response post to the virtual collaboration; and
operably coupling the virtual collaboration to a data analytics interface further operably coupled to at least one data analytics system.

12. The virtual collaboration method of claim 11, wherein the user is prompted by the interaction module to display a record button, a live video feed taken by a video camera, and an overlay of the text on the live video feed, whereby selecting the record button records the live video feed with the overlaid text to generate the response post, the plurality of previously generated virtual collaborations selectable on the user interface to view the collaboration video of the virtual collaboration and implement the interaction module for generating and adding the response post to the virtual collaboration.

13. The virtual collaboration method of claim 11, wherein the user views the interaction module and scrolls to view video capture screens of an associated computing device and adds the response post to the virtual collaboration.

14. The virtual collaboration method of claim 11, wherein the user is prompted through the interaction module to reply to the action command message by options generated wherein the user generates a response post by at least one or more of tapping, swiping, gesturing, and audio commanding at least one or more of text, icons, and multiple-choice icons in associated video capture screens of computing devices and adding the response post to the virtual collaboration.

15. The virtual collaboration method of claim 11, wherein the interaction module prompts reply options to the action command message generated wherein the response post is at least one or more of a text and audio response and adding the response post to the virtual collaboration.

16. The virtual collaboration method of claim 15, wherein the response post includes at least one or more of video and other reality.

17. The virtual collaboration method of claim 11, wherein at least one performance measure is generated by at least one data analytics system from virtual collaboration data either or both received and transmitted through a data analytics interface that is operably coupled to at least one or more of a learning management system, an online performance management system, a massive open online course, a government agency, employee training management, team management, broadcast system, tutoring, online training, a teaching or certification platform, a corporate institution, and an educational institution.

18. The virtual collaboration method of claim 17, wherein the learning performance measure of virtual collaboration includes at least one or more of comprehension, quality of decision, quality of response, time spent, response time length of engagement, user behavior, and quality of standards set by an action command message creator.

19. The virtual collaboration method of claim 18, wherein the learning performance measure of virtual collaboration includes feedback about where a student should focus, efficient learning methods for that student, freedom to advance to new material, and comprehension risks.

20. The virtual collaboration method of claim 11, wherein data from the virtual collaboration is sent through the data analytics interface operably coupled to at least one or more of an enterprise computer network, broadcast network, social media network, and public access network, wherein the virtual collaboration is processed by the at least one computer analytic system to generate at least one or more of content items, content credits, or rewards.
